(19) United States
(12) Patent Application Publication
(10) Pub. No.: US 2026/0046862 A1
(43) Pub. Date: Feb. 12, 2026

(54) USER EQUIPMENT UPLINK RESOURCE MUTING

(71) Applicant: QUALCOMM Incorporated, San Diego, CA (US)

(72) Inventors: Qian ZHANG, Basking Ridge, NJ (US); Muhammad Sayed Khairy ABDELGHAFFAR, San Jose, CA (US); Yan ZHOU, San Diego, CA (US); Abdelrahman Mohamed Ahmed Mohamed IBRAHIM, San Diego, CA (US); Jae Ho RYU, San Diego, CA (US)

(21) Appl. No.: 18/796,040

(22) Filed: Aug. 6, 2024

(51) Int. Cl. H04W 72/1268; H04W 72/044

(52) U.S. Cl. CPC H04W 72/1268; H04W 72/044

(57) ABSTRACT

Various aspects of the present disclosure generally relate to wireless communication. Some aspects more specifically relate to rules, such as implicit rules, for a UE to use in determining whether to apply uplink resource muting to a particular uplink communication in a particular uplink resource. In some aspects, the rules may include frequency domain resource allocation (FDRA) rules, time domain resource allocation (TDRA) rules, or slot type rules, among other examples, as described in more details herein. For example, a UE may determine where a resource is allocated, in an uplink subband, for physical uplink shared channel (PUSCH) transmission, and may determine whether to mute the PUSCH transmission based on where the resource is allocated.

### FIELD OF THE DISCLOSURE

Aspects of the present disclosure generally relate to wireless communication and specifically relate to techniques, apparatuses, and methods associated with user equipment uplink resource muting.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

In sub-band full duplex (SBFD) operation, a single slot may include one or more carriers for downlink transmission and one or more carriers for uplink transmission. For example, a network node may transmit a first communication on a downlink to a first user equipment (UE) and may receive a second communication on an uplink from a second UE. SBFD may provide latency reduction, uplink coverage improvement, enhanced system capacity, enhanced resource utilization efficiency, and flexible resource adaptation. SBFD communications may be subject to interference, such as inter-subband cross-link interference (CLI), intra-cell or inter-cell CLI, or inter-UE CLI. In other words, an uplink transmission from a first UE in a slot may cause interference with a downlink transmission to the first UE, a downlink transmission to a second UE, another uplink transmission by the second UE, or another transmission.

### SUMMARY

Some aspects described herein relate to a method of wireless communication performed at a user equipment (UE). The method may include receiving configuration information associated with scheduling an uplink shared channel transmission in a configured time and frequency resource. The method may include selectively transmitting in at least one portion of the configured time and frequency resource, scheduled for the uplink shared channel, in accordance with a rule, wherein the rule is at least one of: a frequency domain resource allocation rule, a time domain resource allocation rule, or a slot type rule.

Some aspects described herein relate to a method of wireless communication performed at a network node. The method may include transmitting configuration information associated with scheduling an uplink shared channel transmission in a configured time and frequency resource. The method may include receiving in at least one portion of the configured time and frequency resource, scheduled for the uplink shared channel, in accordance with a rule for selective transmission, wherein the rule is at least one of: a frequency domain resource allocation rule, a time domain resource allocation rule, or a slot type rule.

Some aspects described herein relate to a non-transitory computer-readable medium that stores a set of instructions for wireless communication by a UE. The set of instructions, when executed by one or more processors of the UE, may cause the UE to receive configuration information associated with scheduling an uplink shared channel transmission in a configured time and frequency resource. The set of instructions, when executed by one or more processors of the UE, may cause the UE to selectively transmit in at least one portion of the configured time and frequency resource, scheduled for the uplink shared channel, in accordance with a rule, wherein the rule is at least one of: a frequency domain resource allocation rule, a time domain resource allocation rule, or a slot type rule.

Some aspects described herein relate to a non-transitory computer-readable medium that stores a set of instructions for wireless communication by a network node. The set of instructions, when executed by one or more processors of the network node, may cause the network node to transmit configuration information associated with scheduling an uplink shared channel transmission in a configured time and frequency resource. The set of instructions, when executed by one or more processors of the network node, may cause the network node to receive in at least one portion of the configured time and frequency resource, scheduled for the uplink shared channel, in accordance with a rule for selective transmission, wherein the rule is at least one of: a frequency domain resource allocation rule, a time domain resource allocation rule, or a slot type rule.

Some aspects described herein relate to an apparatus for wireless communication at a UE. The apparatus may include one or more memories storing processor-executable code and one or more processors coupled to the one or more memories. At least one processor of the one or more processors may be configured to receive configuration information associated with scheduling an uplink shared channel transmission in a configured time and frequency resource. At least one processor of the one or more processors may be configured to selectively transmit in at least one portion of the configured time and frequency resource, scheduled for the uplink shared channel, in accordance with a rule, wherein the rule is at least one of: a frequency domain resource allocation rule, a time domain resource allocation rule, or a slot type rule.

Some aspects described herein relate to an apparatus for wireless communication at a network node. The apparatus may include one or more memories storing processor-executable code and one or more processors coupled to the one or more memories. At least one processor of the one or more processors may be configured to transmit configuration information associated with scheduling an uplink shared channel transmission in a configured time and frequency resource. At least one processor of the one or more processors may be configured to receive in at least one portion of the configured time and frequency resource, scheduled for the uplink shared channel, in accordance with a rule for selective transmission, wherein the rule is at least one of: a frequency domain resource allocation rule, a time domain resource allocation rule, or a slot type rule.

Some aspects described herein relate to an apparatus for wireless communication. The apparatus may include means for receiving configuration information associated with scheduling an uplink shared channel transmission in a configured time and frequency resource. The apparatus may include means for selectively transmitting in at least one portion of the configured time and frequency resource, scheduled for the uplink shared channel, in accordance with a rule, wherein the rule is at least one of: a frequency domain resource allocation rule, a time domain resource allocation rule, or a slot type rule.

Some aspects described herein relate to an apparatus for wireless communication. The apparatus may include means for transmitting configuration information associated with scheduling an uplink shared channel transmission in a configured time and frequency resource. The apparatus may include means for receiving in at least one portion of the configured time and frequency resource, scheduled for the uplink shared channel, in accordance with a rule for selective transmission, wherein the rule is at least one of: a frequency domain resource allocation rule, a time domain resource allocation rule, or a slot type rule.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network.

FIG. 2 is a diagram illustrating an example network node in communication with an example user equipment (UE) in a wireless network.

FIG. 3 is a diagram illustrating examples of full-duplex communication in a wireless network.

FIGS. 4A-4C are diagrams illustrating an example associated with UE uplink resource muting.

FIG. 5 is a flowchart illustrating an example process performed, for example, at a UE or an apparatus of a UE that supports selective uplink resource muting.

FIG. 6 is a flowchart illustrating an example process performed, for example, at a network node or an apparatus of a network node that communicates with a UE to perform selective uplink resource muting.

FIG. 7 is a diagram of an example apparatus for wireless communication that supports selective uplink resource muting.

FIG. 8 is a diagram of an example apparatus for wireless communication that communicates with another apparatus to perform selective uplink resource muting.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Sub-band full duplex (SBFD) refers to simultaneous bi-directional communication between devices using frequency sub-bands for downlink communication or uplink communication. For example, in SBFD operation, a single slot may include one or more carriers for downlink transmission and one or more carriers for uplink transmission. For example, a network node may transmit a first communication on a downlink to a first user equipment (UE) and may receive a second communication on an uplink from a second UE. SBFD may provide latency reduction, uplink coverage improvement, enhanced system capacity, enhanced resource utilization efficiency, and flexible resource adaptation. SBFD communications may be subject to interference, such as inter-subband cross-link interference (CLI), intra-cell or inter-cell CLI, or inter-UE CLI. In other words, an uplink transmission from a first UE in a slot may cause interference with a downlink transmission to the first UE, a downlink transmission to a second UE, another uplink transmission by the second UE, or another transmission.

To avoid CLI, some uplink resources may be muted. For example, a UE may mute a physical uplink shared channel (PUSCH) transmission to avoid causing interference with a downlink transmission in the same slot. If a UE mutes a transmission unexpectedly, the UE may lack synchronization with a network node resulting in, for example, the network node failing to allocate resources for subsequent transmission. Resource muting may include a pattern of forgoing transmission in some resources (for example, a first one or more resource elements (REs) of a first one or more muted symbols) and transmitting in some other resources (for example, a second one or more REs of a second one or more muted symbols and a third one or more REs of one or more non-muted symbols). In other words, when a UE mutes an uplink transmission, the UE forgoes transmission in some time and frequency resources scheduled for the uplink transmission, but may transmit in other time and frequency resources scheduled for uplink transmission. Similarly, if a UE fails to mute a transmission unexpectedly, the UE may cause interference for which the network node cannot compensate. It may be desirable for a set of rules that provide for deterministic muting of uplink transmissions, thereby avoiding a loss of synchronization between a UE and a network node.

Various aspects described herein relate generally to UE uplink resource muting. Some aspects more specifically relate to rules, such as implicit rules, for a UE to use in determining whether to apply uplink resource muting to a particular uplink communication in a particular uplink resource. In some aspects, the rules may include frequency domain resource allocation (FDRA) rules, time domain resource allocation (TDRA) rules, or slot type rules, among other examples, as described in more details herein. For example, a UE may determine where a resource is allocated, in an uplink subband, for PUSCH transmission, and may determine whether to mute the PUSCH transmission (or apply a pattern of muting to the PUSCH transmission) based on where the resource is allocated (whether the resource is allocated in a middle of an uplink subband or an edge of an uplink subband).

Some aspects relate generally to signaling for UE uplink resource muting. Some aspects more specifically relate to using one or more messages to convey an activation or deactivation of uplink resource muting. For example, a network node may transmit a non-scheduling downlink control information (DCI) message with a field that is repurposed for conveying an indication of an activation of uplink resource muting. Additionally or alternatively, the network node may transmit DCI with a channel state information (CSI) request field that is partially repurposed for conveying an indication of an activation of uplink resource muting. Additionally or alternatively, the network node may transmit DCI for updating a transmission configuration indicator state with a bit repurposed to indicate an activation of uplink resource muting. Additionally or alternatively, the network node may transmit radio resource control (RRC) signaling to configure a mapping table for TDRA with indications of whether uplink resource muting is enabled and may transmit DCI to select a row in the mapping table, thereby conveying an indication of an activation of uplink resource muting.

Particular aspects of the subject matter described in this disclosure can be implemented to realize one or more of the following potential advantages. In some examples, by muting an uplink transmission, the described techniques can be used to avoid CLI in, for example, SBFD communication deployments. Additionally or alternatively, by providing one or more rules for muting an uplink transmission, the described techniques can be used to provide for deterministic muting of the uplink transmission, such that a UE and a network node remain synchronized with regard to whether the UE is to mute a particular transmission on a particular resource. Additionally or alternatively, by providing signaling for activation of uplink resource muting, the described techniques can be used to selectively use or not use uplink resource muting for different communication scenarios or resource allocations.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

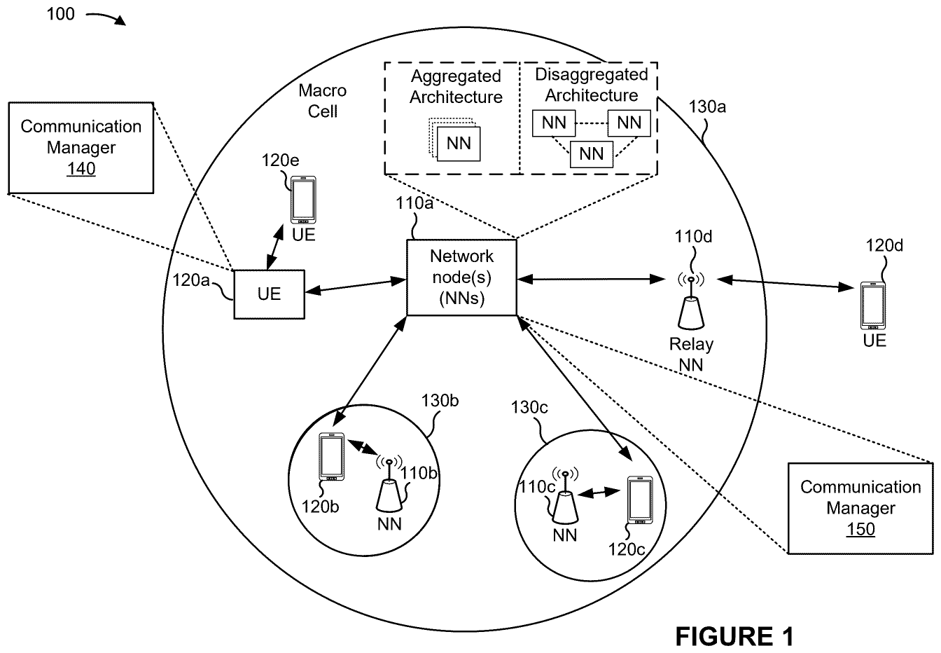

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this example, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication.

In some aspects, the UE 120 may include a communication manager 140. As described in more detail elsewhere herein, the communication manager 140 may receive configuration information associated with scheduling an uplink shared channel transmission in a configured time and frequency resource; and selectively transmitting in at least one portion of the configured time and frequency resource, scheduled for the uplink shared channel, in accordance with a rule, wherein the rule is at least one of: a frequency domain resource allocation rule, a time domain resource allocation rule, or a slot type rule. Additionally or alternatively, the communication manager 140 may perform one or more other operations described herein.

In some aspects, the network node 110 may include a communication manager 150. As described in more detail elsewhere herein, the communication manager 150 may transmit configuration information associated with scheduling an uplink shared channel transmission in a configured time and frequency resource; and receive in at least one portion of the configured time and frequency resource, scheduled for the uplink shared channel, in accordance with a rule for selective transmission, wherein the rule is at least one of: a frequency domain resource allocation rule, a time domain resource allocation rule, or a slot type rule. Additionally or alternatively, the communication manager 150 may perform one or more other operations described herein.

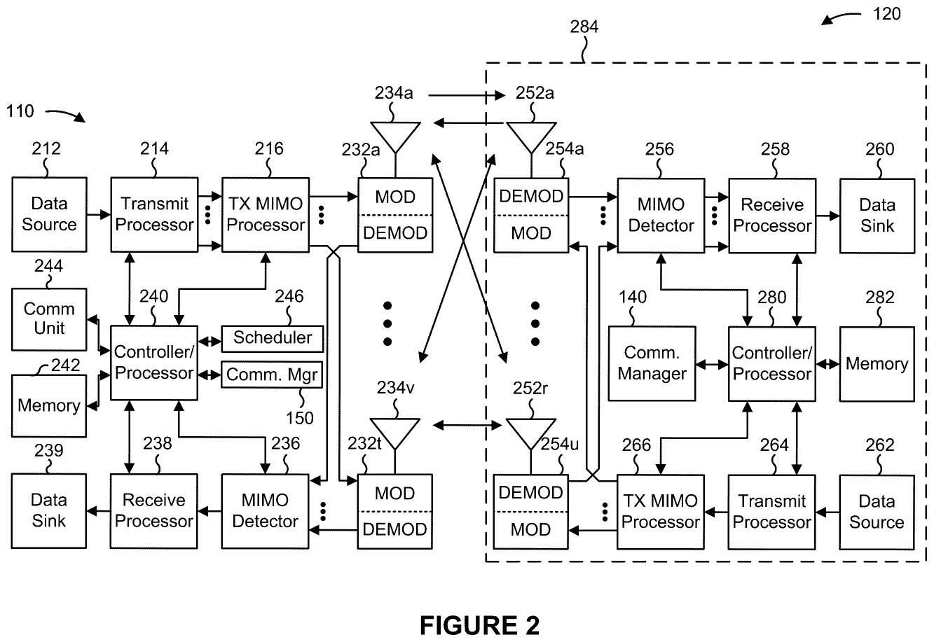

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” or “a/the controller/processor,” among other examples, should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a CSI reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include an uplink control information (UCI) communication, a MAC control element (MAC-CE) communication, an RRC communication, or another type of uplink communication. Uplink signals may be transmitted on a PUSCH, a physical uplink control channel (PUCCH), and/or another type of uplink channel. An uplink signal may carry one or more transport blocks (TBs) of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal.

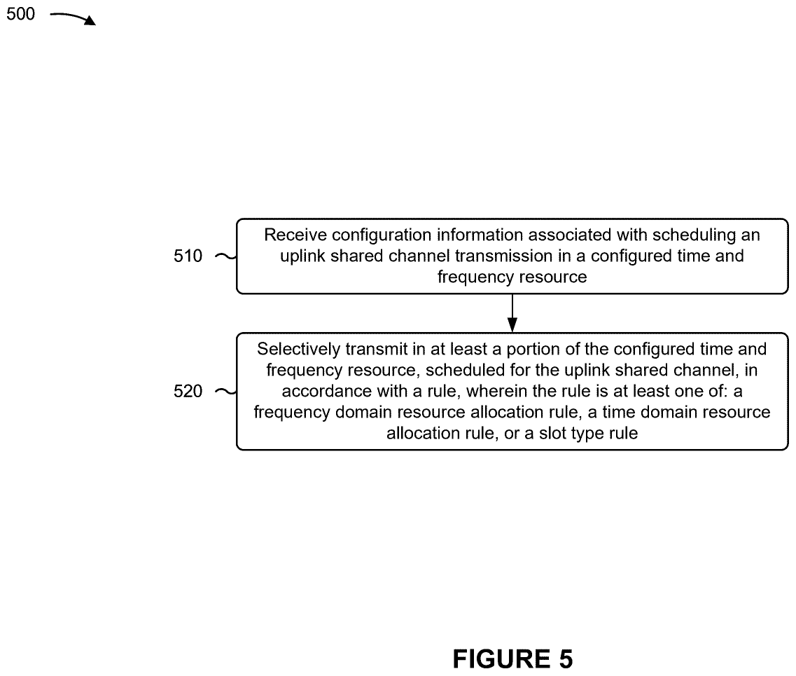

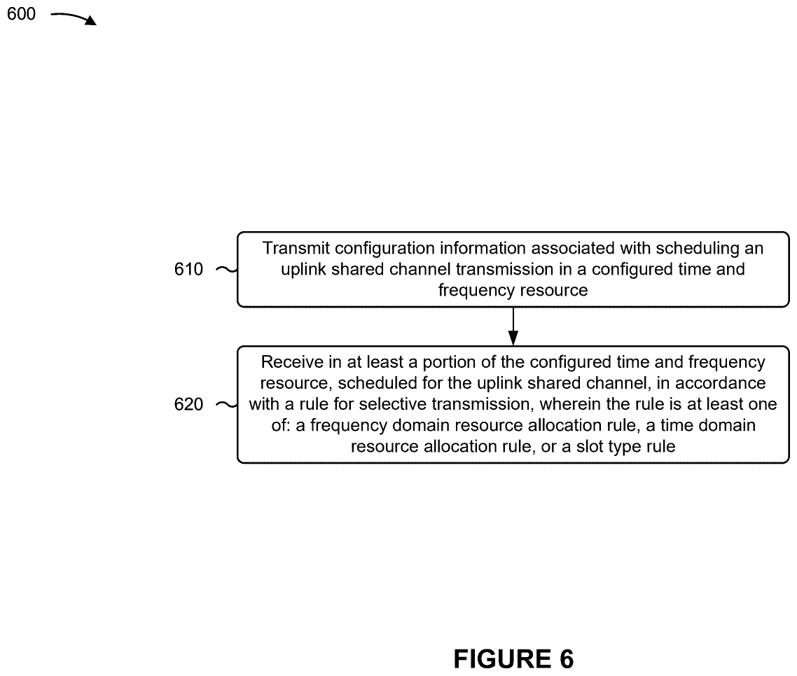

The network node 110, the controller/processor 240 of the network node 110, the UE 120, the controller/processor 280 of the UE 120, a CU, a DU, an RU, or any other component(s) of FIG. 1 or 2 may implement one or more techniques or perform one or more operations associated with uplink resource muting, as described in more detail elsewhere herein. For example, the controller/processor 240 of the network node 110, the controller/processor 280 of the UE 120, any other component(s) of FIG. 2, the CU, the DU, or the RU may perform or direct operations of, for example, process 500 of FIG. 5, process 600 of FIG. 6, or other processes as described herein (alone or in conjunction with one or more other processors). The memory 242 may store data and program codes for the network node 110, the network node 110, the CU, the DU, or the RU. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU, the DU, or the RU, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

In some aspects, the UE 120 includes means for receiving configuration information associated with scheduling an uplink shared channel transmission in a configured time and frequency resource; and/or means for selectively transmitting in at least one portion of the configured time and frequency resource, scheduled for the uplink shared channel, in accordance with a rule, wherein the rule is at least one of: a frequency domain resource allocation rule, a time domain resource allocation rule, or a slot type rule. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting configuration information associated with scheduling an uplink shared channel transmission in a configured time and frequency resource; and/or means for receiving in at least one portion of the configured time and frequency resource, scheduled for the uplink shared channel, in accordance with a rule for selective transmission, wherein the rule is at least one of: a frequency domain resource allocation rule, a time domain resource allocation rule, or a slot type rule. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

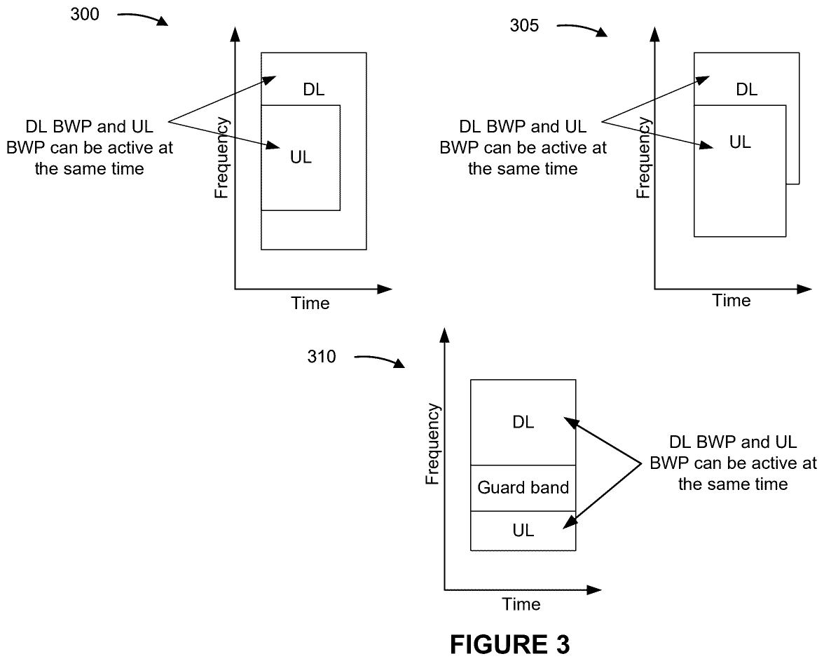

FIG. 3 is a diagram illustrating examples 300, 305, and 310 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an uplink communication and receive a downlink communication at the same time (for example, in the same slot or the same symbol). “Half-duplex communication” in a wireless network refers to unidirectional communications (for example, only downlink communication or only uplink communication) between devices at a given time (for example, in a given slot or a given symbol).

As shown in FIG. 3, examples 300 and 305 show examples of in-band full-duplex (IBFD) communication. In IBFD, a UE may transmit an uplink communication to a base station and receive a downlink communication from the base station on the same time and frequency resources. As shown in example 300, in a first example of IBFD, the time and frequency resources for uplink communication may fully overlap with the time and frequency resources for downlink communication. As shown in example 305, in a second example of IBFD, the time and frequency resources for uplink communication may partially overlap with the time and frequency resources for downlink communication.

As further shown in FIG. 3, example 310 shows an example of SBFD communication, which may also be referred to as “sub-band frequency division duplex (SBFDD)” or “flexible duplex.” In SBFD, a UE may transmit an uplink communication to a base station and receive a downlink communication from the base station at the same time, but on different frequency resources. For example, the different frequency resources may be sub-bands of a frequency band, such as a time division duplexing band. In this example, the frequency resources used for downlink communication may be separated from the frequency resources used for uplink communication, in the frequency domain, by a guard band.

To avoid CLI, some uplink resources may be muted. For example, a UE may mute a PUSCH transmission to avoid causing interference with a downlink transmission in the same slot. If a UE mutes a transmission unexpectedly, the UE may lack synchronization with a network node resulting in, for example, the network node failing to allocate resources for subsequent transmission. Similarly, if a UE fails to mute a transmission unexpectedly, the UE may cause interference for which the network node cannot compensate. It may be desirable for a set of rules that provide for deterministic muting of uplink transmissions, thereby avoiding a loss of synchronization between a UE and a network node.

Various aspects described herein relate generally to UE uplink resource muting. Some aspects more specifically relate to rules, such as implicit rules, for a UE to use in determining whether to apply uplink resource muting to a particular uplink communication in a particular uplink resource. In some aspects, the rules may include FDRA rules, TDRA rules, or slot type rules, among other examples, as described in more details herein. For example, a UE may determine where a resource is allocated, in an uplink subband, for PUSCH transmission, and may determine whether to mute the PUSCH transmission (or apply a pattern of muting to the PUSCH transmission) based on where the resource is allocated (for example, whether the resource is allocated in a middle of an uplink subband or an edge of an uplink subband).

Particular aspects of the subject matter described in this disclosure can be implemented to realize one or more of the following potential advantages. In some examples, by muting an uplink transmission, the described techniques can be used to avoid CLI in, for example, SBFD communications deployments. Additionally or alternatively, by providing one or more rules for muting an uplink transmission, the described techniques can be used to provide for deterministic muting of the uplink transmission, such that a UE and a network node remain synchronized with regard to whether the UE is to mute a particular transmission on a particular resource.

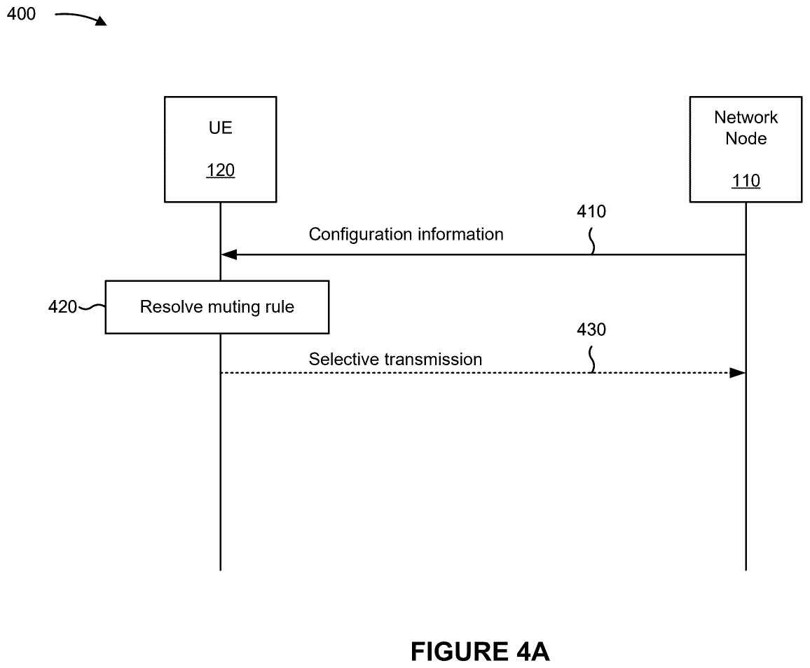

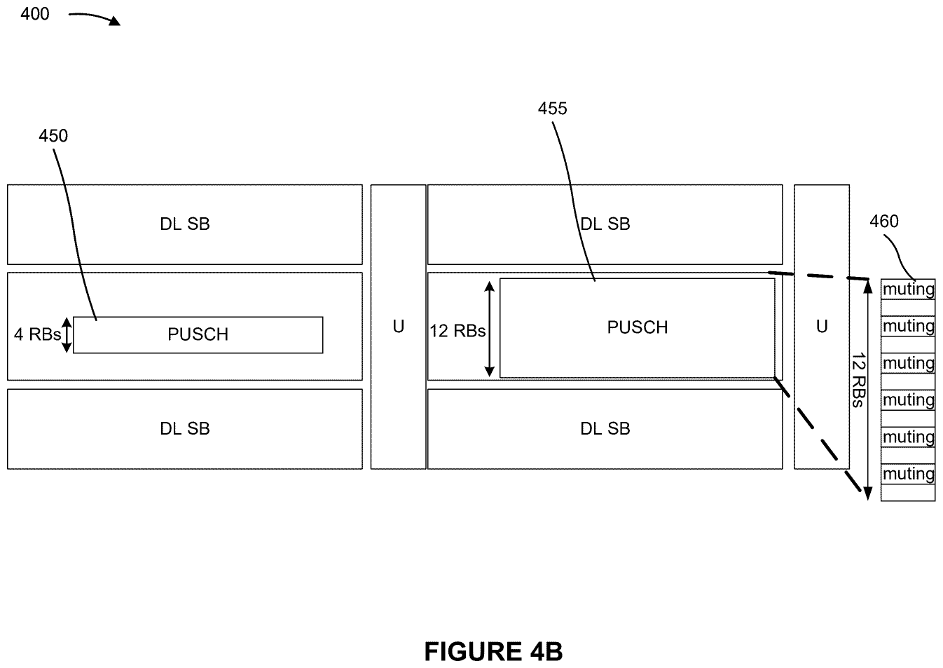

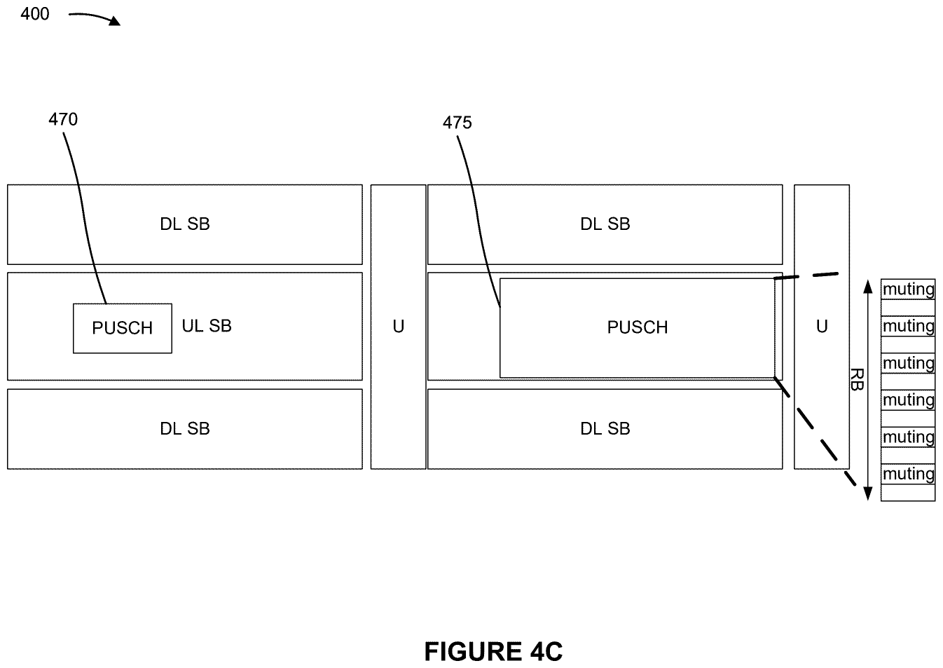

FIGS. 4A-4C are diagrams illustrating an example 400 associated with UE uplink resource muting, in accordance with the present disclosure. As shown in FIG. 4A, example 400 includes communication between a network node 110 and a UE 120.

As further shown in FIG. 4A, in a first operation 410, the UE 120 may receive configuration information. For example, the UE 120 may receive configuration information associated with configuring one or more rules for determining whether to mute an uplink transmission. Additionally or alternatively, the UE 120 may receive configuration information with scheduling a resource for an uplink transmission and for which the UE 120 may determine whether to mute the uplink transmission that is scheduled for the resource. A muted transmission may include a scheduled communication that is canceled, delayed, moved to another communication resource, partially transmitted, or transmitted with altered communication parameters (for example, a reduced transmit power), among other examples. For example, when the UE 120 mutes a transmission, as described in more detail herein, the UE 120 may mute a first subset of a set of symbols allocated for the transmission. In this example, the first subset of the set of symbols, which may be referred to as “muted symbols,” may be further divided into a first one or more REs on which the UE 120 does not transmit and a second one or more REs on which the UE 120 does transmit. Further, when the UE 120 mutes the transmission, the UE 120 may transmit on a third one or more REs of a second subset of the set of symbols, which may be referred to as “non-muted symbols.” Although some aspects are described herein in terms of muting at a symbol or RE level, other types of resource level muting is contemplated, such as resource muting at an RE group (REG) level, a symbol group level, a resource block (RB) level, a slot level, a sub-slot level, or a mini-slot level, among other examples. Although some aspects are described herein in terms of an uplink transmission, it is contemplated that aspects described herein may be used for downlink transmissions, sidelink transmissions, backhaul transmissions, or other types of transmissions.

In some aspects, the UE 120 may receive configuration information as a response to transmitting a capability indicator. For example, the UE 120 may transmit a UE capability indicator indicating a capability for performing uplink resource muting. Additionally or alternatively, the UE 120 may transmit a UE capability indicator indicating a capability for activation or deactivation of uplink resource muting. As described in more detail herein, the UE 120 may receive the configuration information with an activation signal. Additionally or alternatively, the UE 120 may receive first configuration information (for example, associated with configuring a TDRA table for activation signaling) and second configuration information (for example, a selection of a row of the TDRA table that identifies a resource for transmission and whether uplink resource muting is enabled for the resource for transmission).

In some aspects, the UE 120 may receive configuration information from a network node 110. For example, the network node 110 may transmit configuration information identifying a threshold (for example, a threshold quantity of resource or a threshold proximity to an edge of a band, as described in more detail herein) relating to whether to mute an uplink transmission in a scheduled resource. Additionally or alternatively, the UE 120 may receive configuration information identifying a selection of a rule. For example, whether the UE 120 is to use a first configured rule or a second configured rule for determining whether to mute an uplink transmission in a scheduled resource may be based on configuration information received from a network node 110. Additionally or alternatively, the UE 120 may use a priority criterion to determine which configured rule, of a set of configured rules to use. For example, the UE 120 may use a first rule for uplink transmissions with a first priority level and a second rule for uplink transmissions with a second priority level, as described in more detail herein.

In some aspects, the UE 120 may receive configuration information via DCI. For example, the UE 120 may receive DCI conveying configuration information for uplink resource muting of a PUSCH based on a semi-static configuration, and for comb-2 discrete-Fourier-transform (DFT) spread OFDM (DFT-s-OFDM) or cyclic prefix OFDM (CP-OFDM) waveforms in each allocated physical resource block (PRB) with up to 2 symbols in a time domain. In some aspects, the UE 120 may re-interpret an existing field of the DCI to determine the configuration information. For example, the UE 120 may receive a non-scheduling DCI (DCI format 0_1, 0_2, 1_1, or 1_2) and may reinterpret an MCS field, an FDRA field, or a TDRA field, among other examples as conveying an activation message or a deactivation message for uplink resource muting (or use of an uplink resource muting pattern, as described in more detail herein). Additionally or alternatively, the UE 120 may receive an aperiodic (AP) CSI message with a trigger state indicator that maps to a codepoint of a DCI CSI request field. In this example, a maximum quantity of mapped AP trigger states may be 64 (for example, up to 6 bits of the codepoint), and the UE 120 may interpret a first subset of bits (for example, 5 bits) as the codepoint when the network node 110 has not configured all 64 trigger states in RRC signaling. Accordingly, the network node 110 may configure and the UE 120 may interpret the remaining second subset of bits (for example, 1 bit) as an activation or deactivation signal. In some aspects, the UE 120 may receive, from the network node 110, RRC signaling indicating an interpretation of the DCI. For example, the UE 120 may receive RRC signaling indicating that the UE 120 is to interpret 5 bits of a DCI CSI request field as conveying a trigger state and 1 bit as conveying the activation or deactivation signaling.

Additionally or alternatively, the UE 120 may interpret a bit field of a transmission configuration indicator (TCI) state field of a DCI message. For example, the UE 120 may interpret a reserved bit field in DCI format 1_1 that is used to update a TCI state as indicating an activation or deactivation of uplink resource muting (or an uplink resource muting pattern). Additionally or alternatively, the DCI message may include a scrambling radio network temporary identifier (RNTI), such as a CLI RNTI to indicate that the DCI message conveys the activation or deactivation indication. In this example, the indication may be applicable to one or more subsequent uplink transmissions (an activation may be applicable until a deactivation is received).

Additionally or alternatively, the UE 120 may interpret a scheduling DCI, such as DCI formats 0_1 or 0_2, as conveying an indication for uplink resource muting. For example, a TDRA field of a DCI message may include 4 bits, with a column or an entry being added to indicate whether uplink resource muting (or an uplink resource muting pattern) is applicable to a scheduled uplink transmission. In this example, the indication may be applicable to a specific uplink transmission (each scheduled uplink transmission may have a bit indicator of whether uplink resource muting is activated or deactivated).

In some aspects, the UE 120 may receive RRC signaling configuring the additional column or entry conveying whether uplink resource muting is activated for a scheduled uplink transmission. In such an example, the UE 120 may use a custom TDRA table configured by the RRC signaling or a default TDRA table described in one or more telecommunications standards specifications. For example, the UE 120 may use a default TDRA table, as described in more detail with regard to Table 5.1.2.1.1-2 of 3GPP Technical Specification (TS) 38.214, Version 18.3.0, which includes with columns for a row index, a mapping type, and a set of communication parameters. In this example, the UE 120 may receive an RRC signal configuring a custom version of the TDRA table that adds an uplink resource muting column. Accordingly, when the UE 120 receives DCI selecting a row of the custom version of the TDRA table, the UE 120 may use the custom version of the TDRA table to identify whether uplink resource muting is indicated.

As further shown in FIG. 4A, and in a second operation 420, the UE 120 may resolve a muting rule. For example, to determine whether to generate a signal for an uplink transmission in a resource, the UE 120 may determine whether to mute the uplink transmission or transmit the uplink transmission in accordance with a muting rule. The muting rule may include an FDRA muting rule, a TDRA muting rule, or a slot type muting rule, among other examples.

In some aspects, the FDRA muting rule may relate to a quantity of resources. For example, the UE 120 may determine not to perform uplink resource muting on a PUSCH allocated with fewer than a threshold quantity of RBs, as shown in FIG. 4B, and by indicator 450. For example, when a PUSCH is allocated with 4 RBs, as shown, the UE 120 may forgo uplink resource muting and may determine to transmit the PUSCH (in other words, transmit a PUSCH communication on PUSCH resources). Alternatively, as shown in FIG. 4B, and by indicator 455, the UE 120 may determine to perform uplink resource muting (or apply an uplink resource muting pattern, as described in more detail herein), when the PUSCH is allocated with greater than or equal to the threshold quantity of RBs. For example, when the PUSCH is allocated with 12 RBs, the UE 120 may determine to apply a resource muting pattern. In this example, the resource muting pattern includes muting (and not muting) alternating RBs, as shown by indicator 460.

Additionally or alternatively, the FDRA muting rule may relate to a location within a subband of a resource allocation for an uplink transmission. For example, the UE 120 may determine not to perform uplink resource muting on a PUSCH resource that is allocated in a middle of an uplink subband. Additionally or alternatively, the UE 120 may determine not to perform uplink resource muting on a PUSCH resource that is allocated more than a threshold quantity of RBs or REs from an edge of a downlink subband or that is allocated more than a threshold quantity of RBs or REs from a first or last downlink usable PRB in a downlink subband. In contrast, when a PUSCH resource is allocated at or near an edge of an uplink subband (or near a downlink subband), the UE 120 may mute PUSCH transmission in the PUSCH resource. Additionally or alternatively, the FDRA muting rule may relate to an overlap characteristic. For example, the UE 120 may determine to perform muting on a PUSCH resource, when the PUSCH resource is associated with less than a threshold quantity of RBs and is partially overlapped with one or more uplink muted REs. In some aspects, whether the UE 120 uses an FDRA muting rule relating to a quantity of resources, a location within a subband, or an overlap characteristic may be based on the configuration information or a priority level, as described above. For example, when a scheduled PUSCH communication has a high priority level, the UE 120 may use the FDRA muting rules relating to the quantity of resources or the location within the subband, but when the scheduled PUSCH communication has a low priority level, the UE 120 may use the FDRA muting rule relating to the overlap characteristic.

In some aspects, the TDRA muting rule may relate to a quantity of resources. For example, the UE 120 may determine not to perform uplink resource muting on a PUSCH allocated with fewer than a threshold quantity of symbols in a slot or a mini-slot, as shown in FIG. 4C, and by indicator 470. For example, when a PUSCH is allocated with 4 symbols, as shown, the UE 120 may forgo uplink resource muting and may determine to transmit the PUSCH. Alternatively, as shown in FIG. 4C, and by indicator 475, the UE 120 may determine to perform uplink resource muting (or apply an uplink resource muting pattern, as described in more detail herein), when the PUSCH is allocated with greater than or equal to the threshold quantity of symbols. For example, when the PUSCH is allocated with 12 symbols, the UE 120 may determine to apply a resource muting pattern. In some aspects, the UE 120 may be configured with slot-type-specific thresholds. For example, the UE 120 may apply muting for an allocation with greater than or equal to a first threshold quantity of symbols in a slot and may apply muting or a muting pattern for an allocation with greater than or equal to a second threshold quantity of symbols in a mini-slot. Additionally or alternatively, the UE 120 may determine not to apply muting for an allocation in a mini-slot, but may apply muting for an allocation in a slot.

Additionally or alternatively, the TDRA muting rule may relate to an overlap characteristic. For example, the UE 120 may determine to perform muting on a PUSCH resource, when the PUSCH resource is associated with less than a threshold quantity of RBs and is partially overlapped with one or more uplink muted REs. In some aspects, whether the UE 120 uses a TDRA muting rule relating to a quantity of resources, a slot type (for example, a slot or mini-slot), or an overlap characteristic may be based on the configuration information or a priority level, as described above. For example, when a scheduled PUSCH communication has a high priority level, the UE 120 may use the TDRA muting rules relating to the quantity of resources or the slot type, but when the scheduled PUSCH communication has a low priority level, the UE 120 may use the TDRA muting rule relating to the overlap characteristic.

In some aspects, the slot type muting rule may relate to a type of symbol that is configured in a resource. For example, the UE 120 may not perform uplink resource muting on a PUSCH transmission that is scheduled in a resource of a non-SBFD symbol. Alternatively, the UE 120 may perform uplink resource muting on a PUSCH transmission that is scheduled in a resource of an SBFD symbol. Additionally or alternatively, the UE 120 may not perform uplink resource muting on a PUSCH transmission that is in a resource aligned with non-SBFD symbols in one or more other cells. Alternatively, when the resource is not aligned with non-SBFD symbols in any other cells, the UE 120 may perform resource muting on a PUSCH transmission.

As further shown in FIG. 4A, and in a third operation 430, the UE 120 may selectively transmit (for example, selectively mute) an uplink transmission. For example, when the UE 120 resolves the muting rule such that the uplink transmission is to be muted, the UE 120 may mute the uplink transmission, which may include skipping (for example, dropping or terminating), canceling, or delaying the uplink transmission. Additionally or alternatively, muting the transmission may include partially transmitting the transmission, as described above (for example, transmitting the uplink transmission using a muting pattern in which some scheduled time and frequency resources are used for transmitting the uplink transmission and some scheduled time and frequency resources are not used for transmitting the uplink transmission). Additionally or alternatively, muting the transmission may include transmitting the uplink transmission using altered communication parameters, such as transmitting the uplink transmission with an altered transmit power, an altered set of beam parameters (for example, an altered beam angle or TCI state), or an altered MCS, among other examples. Additionally or alternatively, when the UE 120 resolves the muting rule such that the uplink transmission is not to be muted, the UE 120 may transmit the uplink transmission. In some aspects, when the UE 120 resolves the muting rule such that the uplink transmission is to be muted in a first set of resources, the UE 120 may transmit the uplink transmission using a second set of resources. For example, the network node 110 may provide the second set of resources based on determining that the UE 120 is to or has muted the uplink transmission in the first set of resources.

FIG. 5 is a flowchart illustrating an example process 500 performed, for example, at a UE or an apparatus of a UE that supports selective uplink resource muting in accordance with the present disclosure. Example process 500 is an example where the apparatus or the UE (for example, UE 120) performs operations associated with selective uplink resource muting.

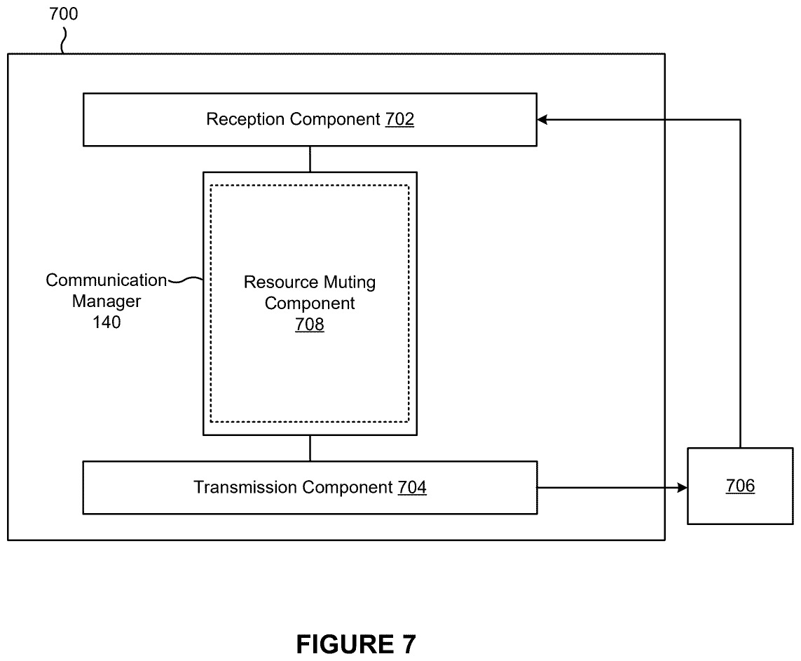

As shown in FIG. 5, in some aspects, process 500 may include receiving configuration information associated with scheduling an uplink shared channel transmission in a configured time and frequency resource (block 510). For example, the UE (such as by using communication manager 140 or reception component 702, depicted in FIG. 7) may receive configuration information associated with scheduling an uplink shared channel transmission in a configured time and frequency resource, as described above.

As further shown in FIG. 5, in some aspects, process 500 may include selectively transmitting in at least one portion of the configured time and frequency resource, scheduled for the uplink shared channel, in accordance with a rule, wherein the rule is at least one of: a frequency domain resource allocation rule, a time domain resource allocation rule, or a slot type rule (block 520). For example, the UE (such as by using communication manager 140 or resource muting component 708, depicted in FIG. 7) may selectively transmit in at least one portion of the configured time and frequency resource, scheduled for the uplink shared channel, in accordance with a rule, wherein the rule is at least one of: a frequency domain resource allocation rule, a time domain resource allocation rule, or a slot type rule, as described above.

Process 500 may include additional aspects, such as any single aspect or any combination of aspects described below or in connection with one or more other processes described elsewhere herein.

In a first additional aspect, the rule is a frequency domain resource allocation rule, and selectively transmitting in the at least one portion of the configured time and frequency resource comprises selectively transmitting in the at least one portion of the configured time and frequency resource in accordance with whether at least a threshold quantity of resource blocks is allocated in the configured time and frequency resource.

In a second additional aspect, alone or in combination with the first aspect, the rule is a frequency domain resource allocation rule, and selectively transmitting in the at least one portion of the configured time and frequency resource comprises selectively transmitting in the at least one portion of the configured time and frequency resource in accordance with a location of the configured time and frequency resource within an uplink sub-band.

In a third additional aspect, alone or in combination with one or more of the first and second aspects, selectively transmitting in the at least one portion of the configured time and frequency resource comprises selectively transmitting in the at least one portion of the configured time and frequency resource based on the location including one or more resources being within a threshold proximity of at least one of an edge of an uplink subband an edge of a downlink subband, or a first or last downlink usable physical resource block in the downlink subband.

In a fourth additional aspect, alone or in combination with one or more of the first through third aspects, selectively transmitting in the at least one portion of the configured time and frequency resource comprises applying an uplink resource muting pattern to the configured time and frequency resource.

In a fifth additional aspect, alone or in combination with one or more of the first through fourth aspects, the rule is a frequency domain resource allocation rule, and selectively transmitting in the at least one portion of the configured time and frequency resource comprises skipping the uplink shared channel transmission in accordance with the frequency domain resource allocation rule.

In a sixth additional aspect, alone or in combination with one or more of the first through fifth aspects, the uplink shared channel transmission is skipped based on the uplink shared channel transmission being allocated in less than a threshold quantity of resources and partially overlapping with one or more muted resources.

In a seventh additional aspect, alone or in combination with one or more of the first through sixth aspects, the rule is a frequency domain resource allocation rule, and selectively transmitting in the at least one portion of the configured time and frequency resource comprises selectively transmitting in the at least one portion of the configured time and frequency resource in accordance with an uplink shared channel priority level or as a response to a received indication.

In an eighth additional aspect, alone or in combination with one or more of the first through seventh aspects, the rule is a time domain resource allocation rule, and selectively transmitting in the at least one portion of the configured time and frequency resource comprises selectively transmitting in the at least one portion of the configured time and frequency resource in accordance with whether at least a threshold quantity of symbols is allocated in the configured time and frequency resource.

In a ninth additional aspect, alone or in combination with one or more of the first through eighth aspects, the rule is a time domain resource allocation rule, and selectively transmitting in the at least one portion of the configured time and frequency resource comprises selectively transmitting in the at least one portion of the configured time and frequency resource in accordance with whether the configured time and frequency resource is a slot or a mini-slot.

In a tenth additional aspect, alone or in combination with one or more of the first through ninth aspects, the rule is a time domain resource allocation rule, and selectively transmitting in the at least one portion of the configured time and frequency resource comprises selectively transmitting in the at least one portion of the configured time and frequency resource in accordance with whether a quantity of allocated symbols in the configured time and frequency resource satisfies a threshold

In an eleventh additional aspect, alone or in combination with one or more of the first through tenth aspects, the rule is a time domain resource allocation rule, and selectively transmitting in the at least one portion of the configured time and frequency resource comprises skipping the uplink shared channel transmission in accordance with the time domain resource allocation rule.

In a twelfth additional aspect, alone or in combination with one or more of the first through eleventh aspects, the uplink shared channel transmission is skipped based on the uplink shared channel transmission being allocated in less than a threshold quantity of resources and partially overlapping with one or more muted resources.

In a thirteenth additional aspect, alone or in combination with one or more of the first through twelfth aspects, the rule is a time domain resource allocation rule, and selectively transmitting in the at least one portion of the configured time and frequency resource comprises selectively transmitting in the at least one portion of the configured time and frequency resource in accordance with an uplink shared channel priority level or as a response to a received indication.

In a fourteenth additional aspect, alone or in combination with one or more of the first through thirteenth aspects, the rule is a slot type rule, and selectively transmitting in the at least one portion of the configured time and frequency resource comprises selectively transmitting in the at least one portion of the configured time and frequency resource in accordance with a type of the configured time and frequency resource.

In a fifteenth additional aspect, alone or in combination with one or more of the first through fourteenth aspects, process 500 includes receiving activation signaling associated with activating selectively transmitting in the at least one portion of the configured time and frequency resource.

In a sixteenth additional aspect, alone or in combination with one or more of the first through fifteenth aspects, process 500 includes transmitting a capability indicator identifying whether the UE supports the activation signaling, and receiving the activation signaling comprises receiving the activation signaling as a response to transmitting the capability indicator.

In a seventeenth additional aspect, alone or in combination with one or more of the first through sixteenth aspects, the activation signaling is conveyed via a value in a field of non-scheduling downlink control information, and the field is at least one of a modulation and coding scheme field or a frequency domain resource allocation field.

In an eighteenth additional aspect, alone or in combination with one or more of the first through seventeenth aspects, the activation signaling is conveyed in connection with a codepoint associated with a downlink control information channel state information request field.

In a nineteenth additional aspect, alone or in combination with one or more of the first through eighteenth aspects, the field is a multi-bit field with a first subset of bits associated with identifying a trigger state and a second subset of bits associated with indicating an activation or deactivation of selectively transmitting in the at least one portion of the configured time and frequency resource.

In a twentieth additional aspect, alone or in combination with one or more of the first through nineteenth aspects, process 500 includes receiving radio resource control signaling associated with configuring an interpretation of the field.

In a twenty-first additional aspect, alone or in combination with one or more of the first through twentieth aspects, the activation signaling is conveyed via a value in a field of a particular format of downlink control information, the particular format of downlink control information includes a reserved field for a transmission configuration indicator state update, and one or more bits of the reserved field are interpretable as an indication to activate or deactivate selectively transmitting in the at least one portion of the configured time and frequency resource.

In a twenty-second additional aspect, alone or in combination with one or more of the first through twenty-first aspects, the activation signaling is conveyed via scheduling downlink control information.

In a twenty-third additional aspect, alone or in combination with one or more of the first through twenty-second aspects, process 500 includes receiving radio resource control information associated with configuring a TDRA table, the TDRA table is configured with an indication of whether to perform selective transmitting in the at least one portion of the configured time and frequency resource in connection with an indication conveyed in the scheduling downlink control information.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a flowchart illustrating an example process 600 performed, for example, at a network node or an apparatus of a network node that supports selective uplink resource muting in accordance with the present disclosure. Example process 600 is an example where the apparatus or the network node (for example, network node 110) performs operations associated with selective uplink resource muting.

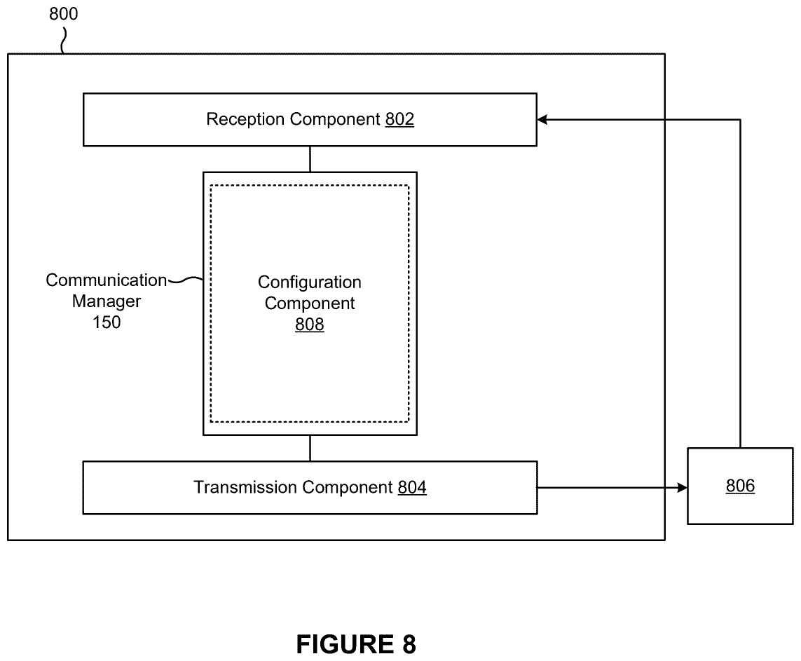

As shown in FIG. 6, in some aspects, process 600 may include transmitting configuration information associated with scheduling an uplink shared channel transmission in a configured time and frequency resource (block 610). For example, the network node (such as by using communication manager 150 or transmission component 804, depicted in FIG. 8) may transmit configuration information associated with scheduling an uplink shared channel transmission in a configured time and frequency resource, as described above.

As further shown in FIG. 6, in some aspects, process 600 may include receiving in at least one portion of the configured time and frequency resource, scheduled for the uplink shared channel, in accordance with a rule for selective transmission, wherein the rule is at least one of: a frequency domain resource allocation rule, a time domain resource allocation rule, or a slot type rule (block 620). For example, the network node (such as by using communication manager 150 or reception component 802, depicted in FIG. 8) may receive in at least one portion of the configured time and frequency resource, scheduled for the uplink shared channel, in accordance with a rule for selective transmission, wherein the rule is at least one of: a frequency domain resource allocation rule, a time domain resource allocation rule, or a slot type rule, as described above.

Process 600 may include additional aspects, such as any single aspect or any combination of aspects described below or in connection with one or more other processes described elsewhere herein.

In a first additional aspect, the rule is a frequency domain resource allocation rule, and the at least one portion of the configured time and frequency resource is selectively transmitted in accordance with whether at least a threshold quantity of resource blocks is allocated in the configured time and frequency resource.

In a second additional aspect, alone or in combination with the first aspect, the rule is a frequency domain resource allocation rule, and the at least one portion of the configured time and frequency resource is selectively transmitted in accordance with a location of the configured time and frequency resource within an uplink sub-band.

In a third additional aspect, alone or in combination with one or more of the first and second aspects, the at least one portion of the configured time and frequency resource is selectively transmitted based on the location including one or more resources being within a threshold proximity of at least one of an edge of an uplink subband an edge of a downlink subband, or a first or last downlink usable physical resource block in the downlink subband.

In a fourth additional aspect, alone or in combination with one or more of the first through third aspects, an uplink resource muting pattern is applied to the configured time and frequency resource.

In a fifth additional aspect, alone or in combination with one or more of the first through fourth aspects, the uplink shared channel transmission is skipped in accordance with a frequency domain resource allocation rule.

In a sixth additional aspect, alone or in combination with one or more of the first through fifth aspects, the uplink shared channel transmission is skipped based on the uplink shared channel transmission being allocated in less than a threshold quantity of resources and partially overlapping with one or more muted resources.

In a seventh additional aspect, alone or in combination with one or more of the first through sixth aspects, the rule is a frequency domain resource allocation rule, and the at least one portion of the configured time and frequency resource is selectively transmitted in accordance with an uplink shared channel priority level or as a response to a received indication.

In an eighth additional aspect, alone or in combination with one or more of the first through seventh aspects, the rule is a time domain resource allocation rule, and the at least one portion of the configured time and frequency resource is selectively transmitted in accordance with whether at least a threshold quantity of symbols is allocated in the configured time and frequency resource.

In a ninth additional aspect, alone or in combination with one or more of the first through eighth aspects, the rule is a time domain resource allocation rule, and the at least one portion of the configured time and frequency resource is selectively transmitted in accordance with whether the configured time and frequency resource is a slot or a mini-slot.

In a tenth additional aspect, alone or in combination with one or more of the first through ninth aspects, the rule is a time domain resource allocation rule, and the at least one portion of the configured time and frequency resource is selectively transmitted in accordance with whether a quantity of allocated symbols in the configured time and frequency resource satisfies a threshold

In an eleventh additional aspect, alone or in combination with one or more of the first through tenth aspects, the rule is a time domain resource allocation rule, and the uplink shared channel transmission is skipped in accordance with the time domain resource allocation rule.

In a twelfth additional aspect, alone or in combination with one or more of the first through eleventh aspects, the uplink shared channel transmission is skipped based on the uplink shared channel transmission being allocated in less than a threshold quantity of resources and partially overlapping with one or more muted resources.

In a thirteenth additional aspect, alone or in combination with one or more of the first through twelfth aspects, the rule is a time domain resource allocation rule, and the at least one portion of the configured time and frequency resource is selectively transmitted in accordance with an uplink shared channel priority level or as a response to a received indication.

In a fourteenth additional aspect, alone or in combination with one or more of the first through thirteenth aspects, the rule is a slot type rule, and the at least one portion of the configured time and frequency resource is selectively transmitted in accordance with a type of the configured time and frequency resource.

In a fifteenth additional aspect, alone or in combination with one or more of the first through fourteenth aspects, process 600 includes transmitting activation signaling associated with activating selectively transmitting in the at least one portion of the configured time and frequency resource.

In a sixteenth additional aspect, alone or in combination with one or more of the first through fifteenth aspects, process 600 includes receiving a capability indicator identifying whether a user equipment supports the activation signaling, and transmitting the activation signaling comprises transmitting the activation signaling as a response to receiving the capability indicator.

In a seventeenth additional aspect, alone or in combination with one or more of the first through sixteenth aspects, the activation signaling is conveyed via a value in a field of non-scheduling downlink control information, and the field is at least one of a modulation and coding scheme field or a frequency domain resource allocation field.

In an eighteenth additional aspect, alone or in combination with one or more of the first through seventeenth aspects, the activation signaling is conveyed in connection with a codepoint associated with a downlink control information channel state information request field.

In a nineteenth additional aspect, alone or in combination with one or more of the first through eighteenth aspects, the field is a multi-bit field with a first subset of bits associated with identifying a trigger state and a second subset of bits associated with indicating an activation or deactivation of selective transmitting in the at least one portion of the configured time and frequency resource.

In a twentieth additional aspect, alone or in combination with one or more of the first through nineteenth aspects, process 600 includes transmitting radio resource control signaling associated with configuring an interpretation of the field.

In a twenty-first additional aspect, alone or in combination with one or more of the first through twentieth aspects, the activation signaling is conveyed via a value in a field of a particular format of downlink control information, the particular format of downlink control information includes a reserved field for a transmission configuration indicator state update, and one or more bits of the reserved field are interpretable as an indication to activate or deactivate selectively transmitting in the at least one portion of the configured time and frequency resource.

In a twenty-second additional aspect, alone or in combination with one or more of the first through twenty-first aspects, the activation signaling is conveyed via scheduling downlink control information.

In a twenty-third additional aspect, alone or in combination with one or more of the first through twenty-second aspects, process 600 includes transmitting radio resource control information associated with configuring a TDRA table, and the TDRA table is configured with an indication of whether to perform selective transmitting in the at least one portion of the configured time and frequency resource in connection with an indication conveyed in the scheduling downlink control information.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a diagram of an example apparatus 700 for wireless communication that supports selective uplink resource muting in accordance with the present disclosure. The apparatus 700 may be a UE, or a UE may include the apparatus 700. In some aspects, the apparatus 700 includes a reception component 702, a transmission component 704, and a communication manager 140, which may be in communication with one another (for example, via one or more buses). As shown, the apparatus 700 may communicate with another apparatus 706 (such as a UE, a network node, or another wireless communication device) using the reception component 702 and the transmission component 704.

In some aspects, the apparatus 700 may be configured to and/or operable to perform one or more operations described herein in connection with FIGS. 4A-4C. Additionally or alternatively, the apparatus 700 may be configured to and/or operable to perform one or more processes described herein, such as process 500 of FIG. 5. In some aspects, the apparatus 700 may include one or more components of the UE described above in connection with FIG. 1 and FIG. 2.

The reception component 702 may receive communications, such as reference signals, control information, and/or data communications, from the apparatus 706. The reception component 702 may provide received communications to one or more other components of the apparatus 700, such as the communication manager 140. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 702 may include one or more antennas, one or more modems, one or more demodulators, one or more MIMO detectors, one or more receive processors, one or more controllers/processors, and/or one or more memories of the UE described above in connection with FIG. 1 and FIG. 2.

The transmission component 704 may transmit communications, such as reference signals, control information, and/or data communications, to the apparatus 706. In some aspects, the communication manager 140 may generate communications and may transmit the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, one or more modems, one or more modulators, one or more transmit MIMO processors, one or more transmit processors, one or more controllers/processors, and/or one or more memories of the UE described above in connection with FIG. 1 and FIG. 2. In some aspects, the transmission component 704 may be co-located with the reception component 702 in one or more transceivers.

The communication manager 140 may receive or may cause the reception component 702 to receive configuration information associated with scheduling an uplink shared channel transmission in a configured time and frequency resource. The communication manager 140 may selectively transmit in at least one portion of the configured time and frequency resource, scheduled for the uplink shared channel, in accordance with a rule, wherein the rule is at least one of: a frequency domain resource allocation rule, a time domain resource allocation rule, or a slot type rule. In some aspects, the communication manager 140 may perform one or more operations described elsewhere herein as being performed by one or more components of the communication manager 140.

The communication manager 140 may include one or more controllers/processors and/or one or more memories of the UE described above in connection with FIG. 1 and FIG. 2. In some aspects, the communication manager 140 includes a set of components, such as a resource muting component 708. Alternatively, the set of components may be separate and distinct from the communication manager 140. In some aspects, one or more components of the set of components may include or may be implemented within one or more controllers/processors and/or one or more memories of the UE described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive configuration information associated with scheduling an uplink shared channel transmission in a configured time and frequency resource. The resource muting component 708 may selectively transmit in at least one portion of the configured time and frequency resource, scheduled for the uplink shared channel, in accordance with a rule, wherein the rule is at least one of: a frequency domain resource allocation rule, a time domain resource allocation rule, or a slot type rule.

The reception component 702 may receive activation signaling associated with activating selectively transmitting in the at least one portion of the configured time and frequency resource. The transmission component 704 may transmit a capability indicator identifying whether the UE supports the activation signaling. The reception component 702 may receive radio resource control signaling associated with configuring an interpretation of the field. The reception component 702 may receive radio resource control information associated with configuring a TDRA table, wherein the TDRA table is configured with an indication of whether to perform selective transmitting in the at least one portion of the configured time and frequency resource in connection with an indication conveyed in the scheduling downlink control information.

The quantity and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

FIG. 8 is a diagram of an example apparatus 800 for wireless communication that supports selective uplink resource muting in accordance with the present disclosure. The apparatus 800 may be a network node, or a network node may include the apparatus 800. In some aspects, the apparatus 800 includes a reception component 802, a transmission component 804, and a communication manager 150, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to and/or operable to perform one or more operations described herein in connection with FIGS. 4A-4C. Additionally or alternatively, the apparatus 800 may be configured to and/or operable to perform one or more processes described herein, such as process 600 of FIG. 6. In some aspects, the apparatus 800 may include one or more components of the network node described above in connection with FIG. 1 and FIG. 2.

The reception component 802 may receive communications, such as reference signals, control information, and/or data communications, from the apparatus 806. The reception component 802 may provide received communications to one or more other components of the apparatus 800, such as the communication manager 150. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, one or more modems, one or more demodulators, one or more MIMO detectors, one or more receive processors, one or more controllers/processors, and/or one or more memories of the network node described above in connection with FIG. 1 and FIG. 2.

The transmission component 804 may transmit communications, such as reference signals, control information, and/or data communications, to the apparatus 806. In some aspects, the communication manager 150 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, one or more modems, one or more modulators, one or more transmit MIMO processors, one or more transmit processors, one or more controllers/processors, and/or one or more memories of the network node described above in connection with FIG. 1 and FIG. 2. In some aspects, the transmission component 804 may be co-located with the reception component 802 in one or more transceivers.

The communication manager 150 may transmit or may cause the transmission component 804 to transmit configuration information associated with scheduling an uplink shared channel transmission in a configured time and frequency resource. The communication manager 150 may receive or may cause the reception component 802 to receive in at least one portion of the configured time and frequency resource, scheduled for the uplink shared channel, in accordance with a rule for selective transmission, wherein the rule is at least one of: a frequency domain resource allocation rule, a time domain resource allocation rule, or a slot type rule. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 1 and FIG. 2. In some aspects, the communication manager 150 includes a set of components, such as a configuration component 808. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 804 may transmit configuration information associated with scheduling an uplink shared channel transmission in a configured time and frequency resource. The reception component 802 may receive in at least one portion of the configured time and frequency resource, scheduled for the uplink shared channel, in accordance with a rule for selective transmission, wherein the rule is at least one of: a frequency domain resource allocation rule, a time domain resource allocation rule, or a slot type rule. The configuration component 808 may configure one or more parameters associated with uplink resource muting.

The transmission component 804 may transmit activation signaling associated with activating selectively transmitting in the at least one portion of the configured time and frequency resource. The reception component 802 may receive a capability indicator identifying whether a user equipment supports the activation signaling. The transmission component 804 may transmit radio resource control signaling associated with configuring an interpretation of the field. The transmission component 804 may transmit radio resource control information associated with configuring a TDRA table, wherein the TDRA table is configured with an indication of whether to perform selective transmitting in the at least one portion of the configured time and frequency resource in connection with an indication conveyed in the scheduling downlink control information.

The quantity and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed at a user equipment (UE), comprising: receiving configuration information associated with scheduling an uplink shared channel transmission in a configured time and frequency resource; and selectively transmitting in at least one portion of the configured time and frequency resource, scheduled for the uplink shared channel, in accordance with a rule, wherein the rule is at least one of: a frequency domain resource allocation rule, a time domain resource allocation rule, or a slot type rule.

Aspect 2: The method of Aspect 1, wherein the rule is a frequency domain resource allocation rule, and wherein selectively transmitting in the at least one portion of the configured time and frequency resource comprises: selectively transmitting in the at least one portion of the configured time and frequency resource in accordance with whether at least a threshold quantity of resource blocks is allocated in the configured time and frequency resource.

Aspect 3: The method of any of Aspects 1-2, wherein the rule is a frequency domain resource allocation rule, and wherein selectively transmitting in the at least one portion of the configured time and frequency resource comprises: selectively transmitting in the at least one portion of the configured time and frequency resource in accordance with a location of the configured time and frequency resource within an uplink sub-band.

Aspect 4: The method of Aspect 3, wherein selectively transmitting in the at least one portion of the configured time and frequency resource comprises: selectively transmitting in the at least one portion of the configured time and frequency resource based on the location including one or more resources being within a threshold proximity of at least one of: an edge of an uplink subband an edge of a downlink subband, or a first or last downlink usable physical resource block in the downlink subband.

Aspect 5: The method of any of Aspects 1-4, wherein selectively transmitting in the at least one portion of the configured time and frequency resource comprises: applying an uplink resource muting pattern to the configured time and frequency resource.

Aspect 6: The method of any of Aspects 1-5, wherein the rule is a frequency domain resource allocation rule, and wherein selectively transmitting in the at least one portion of the configured time and frequency resource comprises: skipping the uplink shared channel transmission in accordance with the frequency domain resource allocation rule.

Aspect 7: The method of Aspect 6, wherein the uplink shared channel transmission is skipped based on the uplink shared channel transmission being allocated in less than a threshold quantity of resources and partially overlapping with one or more muted resources.

Aspect 8: The method of any of Aspects 1-7, wherein the rule is a frequency domain resource allocation rule, and wherein selectively transmitting in the at least one portion of the configured time and frequency resource comprises: selectively transmitting in the at least one portion of the configured time and frequency resource in accordance with an uplink shared channel priority level or as a response to a received indication.

Aspect 9: The method of any of Aspects 1-8, wherein the rule is a time domain resource allocation rule, and wherein selectively transmitting in the at least one portion of the configured time and frequency resource comprises: selectively transmitting in the at least one portion of the configured time and frequency resource in accordance with whether at least a threshold quantity of symbols is allocated in the configured time and frequency resource.

Aspect 10: The method of any of Aspects 1-9, wherein the rule is a time domain resource allocation rule, and wherein selectively transmitting in the at least one portion of the configured time and frequency resource comprises: selectively transmitting in the at least one portion of the configured time and frequency resource in accordance with whether the configured time and frequency resource is a slot or a mini-slot.

Aspect 11: The method of any of Aspects 1-10, wherein the rule is a time domain resource allocation rule, and wherein selectively transmitting in the at least one portion of the configured time and frequency resource comprises: selectively transmitting in the at least one portion of the configured time and frequency resource in accordance with whether a quantity of allocated symbols in the configured time and frequency resource satisfies a threshold

Aspect 12: The method of any of Aspects 1-11, wherein the rule is a time domain resource allocation rule, and wherein selectively transmitting in the at least one portion of the configured time and frequency resource comprises: skipping the uplink shared channel transmission in accordance with the time domain resource allocation rule.

Aspect 13: The method of Aspect 12, wherein the uplink shared channel transmission is skipped based on the uplink shared channel transmission being allocated in less than a threshold quantity of resources and partially overlapping with one or more muted resources.

Aspect 14: The method of Aspect 12, wherein the rule is a time domain resource allocation rule, and wherein selectively transmitting in the at least one portion of the configured time and frequency resource comprises: selectively transmitting in the at least one portion of the configured time and frequency resource in accordance with an uplink shared channel priority level or as a response to a received indication.

Aspect 15: The method of any of Aspects 1-14, wherein the rule is a slot type rule, and wherein selectively transmitting in the at least one portion of the configured time and frequency resource comprises: selectively transmitting in the at least one portion of the configured time and frequency resource in accordance with a type of the configured time and frequency resource.

Aspect 16: The method of any of Aspects 1-15, further comprising: receiving activation signaling associated with activating selectively transmitting in the at least one portion of the configured time and frequency resource.

Aspect 17: The method of Aspect 16, further comprising: transmitting a capability indicator identifying whether the UE supports the activation signaling; and wherein receiving the activation signaling comprises: receiving the activation signaling as a response to transmitting the capability indicator.

Aspect 18: The method of Aspect 16, wherein the activation signaling is conveyed via a value in a field of non-scheduling downlink control information, and wherein the field is at least one of: a modulation and coding scheme field or a frequency domain resource allocation field.

Aspect 19: The method of Aspect 16, wherein the activation signaling is conveyed in connection with a codepoint associated with a downlink control information channel state information request field.

Aspect 20: The method of Aspect 19, wherein the field is a multi-bit field with a first subset of bits associated with identifying a trigger state and a second subset of bits associated with indicating an activation or deactivation of selectively transmitting in the at least one portion of the configured time and frequency resource.

Aspect 21: The method of Aspect 19, further comprising: receiving radio resource control signaling associated with configuring an interpretation of the field.

Aspect 22: The method of Aspect 16, wherein the activation signaling is conveyed via a value in a field of a particular format of downlink control information, wherein the particular format of downlink control information includes a reserved field for a transmission configuration indicator state update, and wherein one or more bits of the reserved field are interpretable as an indication to activate or deactivate selectively transmitting in the at least one portion of the configured time and frequency resource.

Aspect 23: The method of Aspect 16, wherein the activation signaling is conveyed via scheduling downlink control information.

Aspect 24: The method of Aspect 23, further comprising: receiving radio resource control information associated with configuring a time domain resource allocation (TDRA) table, wherein the TDRA table is configured with an indication of whether to perform selective transmitting in the at least one portion of the configured time and frequency resource in connection with an indication conveyed in the scheduling downlink control information.

Aspect 25: A method of wireless communication performed at a network node, comprising: transmitting configuration information associated with scheduling an uplink shared channel transmission in a configured time and frequency resource; and receiving in at least one portion of the configured time and frequency resource, scheduled for the uplink shared channel, in accordance with a rule for selective transmission, wherein the rule is at least one of: a frequency domain resource allocation rule, a time domain resource allocation rule, or a slot type rule.

Aspect 26: The method of Aspect 25, wherein the rule is a frequency domain resource allocation rule, and wherein the at least one portion of the configured time and frequency resource is selectively transmitted in accordance with whether at least a threshold quantity of resource blocks is allocated in the configured time and frequency resource.

Aspect 27: The method of any of Aspects 25-26, wherein the rule is a frequency domain resource allocation rule, and wherein the at least one portion of the configured time and frequency resource is selectively transmitted in accordance with a location of the configured time and frequency resource within an uplink sub-band.

Aspect 28: The method of Aspect 27, wherein the at least one portion of the configured time and frequency resource is selectively transmitted based on the location including one or more resources being within a threshold proximity of at least one of: an edge of an uplink subband an edge of a downlink subband, or a first or last downlink usable physical resource block in the downlink subband.

Aspect 29: The method of any of Aspects 25-28, wherein an uplink resource muting pattern is applied to the configured time and frequency resource.

Aspect 30: The method of any of Aspects 25-29, wherein the uplink shared channel transmission is skipped in accordance with a frequency domain resource allocation rule.

Aspect 31: The method of Aspect 30, wherein the uplink shared channel transmission is skipped based on the uplink shared channel transmission being allocated in less than a threshold quantity of resources and partially overlapping with one or more muted resources.

Aspect 32: The method of any of Aspects 25-31, wherein the rule is a frequency domain resource allocation rule, and wherein the at least one portion of the configured time and frequency resource is selectively transmitted in accordance with an uplink shared channel priority level or as a response to a received indication.

Aspect 33: The method of any of Aspects 25-32, wherein the rule is a time domain resource allocation rule, and wherein the at least one portion of the configured time and frequency resource is selectively transmitted in accordance with whether at least a threshold quantity of symbols is allocated in the configured time and frequency resource.

Aspect 34: The method of any of Aspects 25-33, wherein the rule is a time domain resource allocation rule, and wherein the at least one portion of the configured time and frequency resource is selectively transmitted in accordance with whether the configured time and frequency resource is a slot or a mini-slot.

Aspect 35: The method of any of Aspects 25-34, wherein the rule is a time domain resource allocation rule, and wherein the at least one portion of the configured time and frequency resource is selectively transmitted in accordance with whether a quantity of allocated symbols in the configured time and frequency resource satisfies a threshold

Aspect 36: The method of any of Aspects 25-35, wherein the rule is a time domain resource allocation rule, and wherein the uplink shared channel transmission is skipped in accordance with the time domain resource allocation rule.

Aspect 37: The method of Aspect 36, wherein the uplink shared channel transmission is skipped based on the uplink shared channel transmission being allocated in less than a threshold quantity of resources and partially overlapping with one or more muted resources.

Aspect 38: The method of Aspect 36, wherein the rule is a time domain resource allocation rule, and wherein the at least one portion of the configured time and frequency resource is selectively transmitted in accordance with an uplink shared channel priority level or as a response to a received indication.

Aspect 39: The method of any of Aspects 25-38, wherein the rule is a slot type rule, and wherein the at least one portion of the configured time and frequency resource is selectively transmitted in accordance with a type of the configured time and frequency resource.

Aspect 40: The method of any of Aspects 25-39, further comprising: transmitting activation signaling associated with activating selectively transmitting in the at least one portion of the configured time and frequency resource.

Aspect 41: The method of Aspect 40, further comprising: receiving a capability indicator identifying whether a user equipment supports the activation signaling; and wherein transmitting the activation signaling comprises: transmitting the activation signaling as a response to receiving the capability indicator.

Aspect 42: The method of Aspect 40, wherein the activation signaling is conveyed via a value in a field of non-scheduling downlink control information, and wherein the field is at least one of: a modulation and coding scheme field or a frequency domain resource allocation field.

Aspect 43: The method of Aspect 40, wherein the activation signaling is conveyed in connection with a codepoint associated with a downlink control information channel state information request field.

Aspect 44: The method of Aspect 43, wherein the field is a multi-bit field with a first subset of bits associated with identifying a trigger state and a second subset of bits associated with indicating an activation or deactivation of selective transmitting in the at least one portion of the configured time and frequency resource.

Aspect 45: The method of Aspect 43, further comprising: transmitting radio resource control signaling associated with configuring an interpretation of the field.

Aspect 46: The method of Aspect 40, wherein the activation signaling is conveyed via a value in a field of a particular format of downlink control information, wherein the particular format of downlink control information includes a reserved field for a transmission configuration indicator state update, and wherein one or more bits of the reserved field are interpretable as an indication to activate or deactivate selectively transmitting in the at least one portion of the configured time and frequency resource.

Aspect 47: The method of Aspect 40, wherein the activation signaling is conveyed via scheduling downlink control information.

Aspect 48: The method of Aspect 47, further comprising: transmitting radio resource control information associated with configuring a time domain resource allocation (TDRA) table, wherein the TDRA table is configured with an indication of whether to perform selective transmitting in the at least one portion of the configured time and frequency resource in connection with an indication conveyed in the scheduling downlink control information.

Aspect 49: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-48.

Aspect 50: An apparatus for wireless communication at a device, the apparatus comprising one or more memories and one or more processors coupled to the one or more memories, the one or more processors configured to cause the device to perform the method of one or more of Aspects 1-48.

Aspect 51: An apparatus for wireless communication, the apparatus comprising at least one means for performing the method of one or more of Aspects 1-48.

Aspect 52: A non-transitory computer-readable medium storing code for wireless communication, the code comprising instructions executable by one or more processors to perform the method of one or more of Aspects 1-48.

Aspect 53: A non-transitory computer-readable medium storing a set of instructions for wireless communication, the set of instructions comprising one or more instructions that, when executed by one or more processors of a device, cause the device to perform the method of one or more of Aspects 1-48.

Aspect 54: A device for wireless communication, the device comprising a processing system that includes one or more processors and one or more memories coupled with the one or more processors, the processing system configured to cause the device to perform the method of one or more of Aspects 1-48.

Aspect 55: An apparatus for wireless communication at a device, the apparatus comprising one or more memories and one or more processors coupled to the one or more memories, the one or more processors individually or collectively configured to cause the device to perform the method of one or more of Aspects 1-48.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, the term “determine” or “determining” encompasses a wide variety of actions and, therefore, “determining” can include calculating, computing, processing, deriving, investigating, looking up (such as via looking up in a table, a database or another data structure), identifying, inferring, ascertaining, measuring, and the like. Also, “determining” can include receiving (such as receiving information or receiving an indication), accessing (such as accessing data stored in memory), transmitting (such as transmitting information) and the like. Also, “determining” can include resolving, selecting, obtaining, choosing, establishing and other such similar actions. The term “identify” or “identifying” also encompasses a wide variety of actions and, therefore, “identifying” can include calculating, computing, processing, deriving, investigating, looking up (such as via looking up in a table, a database or another data structure), inferring, ascertaining, measuring, and the like. Also, “identifying” can include receiving (such as receiving information or receiving an indication), accessing (such as accessing data stored in memory), transmitting (such as transmitting information) and the like. Also, “identifying” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, as used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled to the one or more memories, at least one processor of the one or more processors configured to cause the UE to:
receive configuration information associated with scheduling an uplink shared channel transmission in a configured time and frequency resource; and
selectively transmit in at least one portion of the configured time and frequency resource, scheduled for the uplink shared channel, in accordance with a rule, wherein the rule is at least one of: a frequency domain resource allocation rule, a time domain resource allocation rule, or a slot type rule.

2. The apparatus of claim 1, wherein the rule is a frequency domain resource allocation rule, and wherein at least one processor of the one or more processors is configured to cause the UE to:
selectively transmit in the at least one portion of the configured time and frequency resource in accordance with whether at least a threshold quantity of resource blocks is allocated in the configured time and frequency resource.

3. The apparatus of claim 1, wherein at least one processor of the one or more processors is configured to cause the UE to:
selectively transmit in the at least one portion of the configured time and frequency resource based on a location of the configured time and frequency resource including one or more resources within a threshold proximity of at least one of:
an edge of an uplink subband
an edge of a downlink subband, or
a first or last downlink usable physical resource block in the downlink subband.

4. The apparatus of claim 1, wherein the rule is a time domain resource allocation rule, and wherein at least one processor of the one or more processors is configured to cause the UE to:
selectively transmit in the at least one portion of the configured time and frequency resource in accordance with whether at least a threshold quantity of symbols is allocated in the configured time and frequency resource.

5. The apparatus of claim 1, wherein the rule is a time domain resource allocation rule, and wherein at least one processor of the one or more processors is configured to cause the UE to:
selectively transmit in the at least one portion of the configured time and frequency resource in accordance with whether a quantity of allocated symbols in the configured time and frequency resource satisfies a threshold.

6. The apparatus of claim 1, wherein at least one processor of the one or more processors is configured to cause the UE to:
receive activation signaling associated with activating selectively transmitting in the at least one portion of the configured time and frequency resource.

7. The apparatus of claim 6, wherein at least one processor of the one or more processors is configured to cause the UE to:
transmit a capability indicator identifying whether the UE supports the activation signaling; and
receive the activation signaling as a response to transmitting the capability indicator.

8. The apparatus of claim 6, wherein the activation signaling is conveyed via a value in a field of non-scheduling downlink control information, and wherein the field is at least one of:
a modulation and coding scheme field or
a frequency domain resource allocation field.

9. A method of wireless communication performed at a user equipment (UE), comprising:
receiving configuration information associated with scheduling an uplink shared channel transmission in a configured time and frequency resource; and
selectively transmitting in at least one portion of the configured time and frequency resource, scheduled for the uplink shared channel, in accordance with a rule, wherein the rule is at least one of: a frequency domain resource allocation rule, a time domain resource allocation rule, or a slot type rule.

10. The method of claim 9, wherein the rule is a frequency domain resource allocation rule, and wherein selectively transmitting in the at least one portion of the configured time and frequency resource comprises:
selectively transmitting in the at least one portion of the configured time and frequency resource in accordance with a location of the configured time and frequency resource within an uplink sub-band.

11. The method of claim 9, wherein selectively transmitting in the at least one portion of the configured time and frequency resource comprises:
applying an uplink resource muting pattern to the configured time and frequency resource.

12. The method of claim 9, wherein the rule is a frequency domain resource allocation rule, and wherein selectively transmitting in the at least one portion of the configured time and frequency resource comprises:
selectively transmitting in the at least one portion of the configured time and frequency resource in accordance with an uplink shared channel priority level or as a response to a received indication.

13. The method of claim 9, wherein the rule is a time domain resource allocation rule, and wherein selectively transmitting in the at least one portion of the configured time and frequency resource comprises:
selectively transmitting in the at least one portion of the configured time and frequency resource in accordance with whether the configured time and frequency resource is a slot or a mini-slot.

14. The method of claim 9, wherein the rule is a time domain resource allocation rule, and wherein selectively transmitting in the at least one portion of the configured time and frequency resource comprises:
skipping the uplink shared channel transmission in accordance with the time domain resource allocation rule.

15. The method of claim 14, wherein the uplink shared channel transmission is skipped based on the uplink shared channel transmission being allocated in less than a threshold quantity of resources and partially overlapping with one or more muted resources.

16. The method of claim 9, wherein the rule is a slot type rule, and wherein selectively transmitting in the at least one portion of the configured time and frequency resource comprises:
selectively transmitting in the at least one portion of the configured time and frequency resource in accordance with a type of the configured time and frequency resource.

17. An apparatus for wireless communication at a network node, comprising:
one or more memories storing processor-executable code; and
one or more processors coupled to the one or more memories, at least one processor of the one or more processors configured to cause the network node to:
transmit configuration information associated with scheduling an uplink shared channel transmission in a configured time and frequency resource; and
receive in at least one portion of the configured time and frequency resource, scheduled for the uplink shared channel, in accordance with a rule for selective transmission, wherein the rule is at least one of: a frequency domain resource allocation rule, a time domain resource allocation rule, or a slot type rule.

18. The apparatus of claim 17, wherein activation signaling for the selective transmission is conveyed in connection with a codepoint associated with a downlink control information channel state information request field.

19. The apparatus of claim 17, wherein activation signaling for the selective transmission is conveyed via a value in a field of a particular format of downlink control information, wherein the particular format of downlink control information includes a reserved field for a transmission configuration indicator state update, and
wherein one or more bits of the reserved field are interpretable as an indication to activate or deactivate selectively transmitting in the at least one portion of the configured time and frequency resource.

20. The apparatus of claim 17, wherein activation signaling for the selective transmission is conveyed via scheduling downlink control information.
